(19) United States
(12) Patent Application Publication
(10) Pub. No.: US 2012/0191470 A1
(43) Pub. Date: Jul. 26, 2012

(54) Method And System For Improving Oral Health

(75) Inventors: Jeanine Leslie Winston, Maineville, OH (US); Marianne Gorby, Cincinnati, OH (US)

(73) Assignee: The Procler & Gamble Company, Cincinnati, OH (US)

(21) Appl. No.: 13/357,785

(22) Filed: Jan. 25, 2012

Related U.S. Application Data
(60) Provisional application No. 61/435,845, filed on Jan. 25, 2011.

(51) Int. Cl. G06Q 50/22

(52) U.S. Cl. 705/2

(57) ABSTRACT

Methods provide for improving the oral health of a consumer. One embodiment of a method includes (a) collecting input information from the consumer regarding at least one characteristic associated with oral health of the consumer; (b) analyzing the input information; (c) using the analysis from step b) to develop a customized at-home oral care treatment regimen, wherein the regimen includes identifying at least one oral care product that will be effective in improving oral health of the consumer; and (d) providing the at-home oral care treatment regimen to the consumer.

### CROSS REFERENCE TO RELATED APPLICATION

This application claims the benefit of U.S. Provisional Application No. 61/435,845, filed on Jan. 25, 2011, which is incorporated herein by reference.

### FIELD OF THE INVENTION

The present disclosure relates generally to methods for improving the oral health of a consumer. More particularly, the present disclosure relates to methods for providing an at-home oral care treatment regimen for a consumer. Another aspect of the present disclosure relates to a system for managing the oral health of a consumer.

### BACKGROUND OF THE INVENTION

Periodontal diseases affect approximately 35% of American adults between the ages of thirty and ninety years old, making it one of our most common diseases. These infectious diseases have been classified as gingivitis (gum inflammation), chronic periodontitis (gum disease), aggressive periodontitis, periodontitis associated with systemic disease, necrotizing periodontitis, periodontal abscess and periodontic-endodontic lesions. Gingivitis and chronic and aggressive periodontitis comprise, by far, the most commonly observed periodontal conditions.

In the early stage of gingivitis, bacteria in plaque build-up, causes the gums to become inflamed (red and swollen) and often easily bleed during tooth brushing. Although the gums may be irritated, the teeth are still firmly planted in their sockets. No irreversible bone or other tissue damage has occurred at this stage.

When gingivitis is left untreated, it can advance to periodontitis. In a person with periodontitis, the inner layer of the gum and bone pull away from the teeth and form pockets. These small spaces between teeth and gums collect debris and can become infected. The body's immune system fights the bacteria as the plaque spreads and grows below the gum line. Toxins or poisons—produced by the bacteria in plaque as well as the body's “good” enzymes involved in fighting infections—start to break down the bone and connective tissue that hold teeth in place. As the disease progresses, the pockets deepen and more gum tissue and bone are destroyed. When this happens, teeth are no longer anchored in place, they become loose and tooth loss occurs. Gum disease, in fact, is the leading cause of tooth loss in adults.

Methods of treating periodontal diseases depend on the diagnosis that is made after a comprehensive periodontal examination performed by a dental professional. Factors upon which these decisions are made include dental and medical histories, assessment of gingival inflammation, (for example, bleeding on probing), probing pocket depth, extent and pattern of alveolar bone loss, and presence or absence of sign and symptoms including pain, ulceration, and amount of observable plaque and calculus. Once the diagnosis is made, appropriate interventions or treatment plan is recommended. Such treatment plans generally involve the use of over-the-counter (OTC) oral care products for use at-home.

In the case of improving oral health, such as gum health, at-home treatments generally include manual toothbrushes, power toothbrushes, interdental toothbrushes, floss, toothpaste or dentifrice and rinse or mouthwash. Manufacturers of these oral care products may provide multiple versions of a type or brand, wherein each of the multiple versions is specifically designed to target a need or demand which is characteristic of a specific oral health condition or disease. For example, a single brand of toothpaste may offer a first version designed to help protect against cavities and a second version designed to help protect against plaque, both conditions associated with oral health.

However, when a consumer is faced with the task of selecting an at-home oral health product from among the multiple versions of an oral care brand, the consumer may unknowingly select a version which is not designed to provide the benefits or characteristics desired by the consumer. In such a case, the consumer may be dissatisfied with the results of the selected version of the oral care brand. As a result of the consumer's dissatisfaction, the consumer subsequently may refuse to select any of the versions of that same oral care brand even though another version of that oral care brand may provide the consumer's desired oral and/or gum health characteristics. The occurrence of such circumstances, in turn, may lead to unnecessary loss of sales of the particular oral care brand for the manufacturer.

Methods of periodontal diagnosis, treatment planning and communicating this information to the patient have been developed in the past to try to improve overall oral health. However, none of these methods combine oral health diagnosis with a focused at-home oral care treatment regimen using specifically recommended oral care products to improve a current risk condition.

### SUMMARY OF THE INVENTION

In one embodiment, a method for improving oral health of a consumer is provided. The method comprises the steps of: (a) collecting input information from the consumer regarding at least one characteristic associated with oral health of the consumer; (b) analyzing the input information; (c) using the analysis from step b) to develop a customized at-home oral care treatment regimen, wherein the regimen includes identifying at least one oral care product that will be effective in improving oral health of the consumer; and (d) providing the at-home oral care treatment regimen to the consumer.

In another embodiment, a method for providing a customized at-home oral care treatment regimen to a consumer is provided. The method comprises the steps of: (a) assessing the oral health of the consumer; (b) assigning a gum health indicator, the indicator corresponding to the oral health assessment; (c) using the gum health indicator to develop the at-home oral care treatment regimen for the consumer; and (d) providing the at-home oral care treatment regimen to the consumer thereby allowing the consumer to use the at-home oral care treatment regimen in a manner to improve oral health.

In another embodiment, a system for managing oral health is provided. The system includes a device for inputting and displaying information regarding at least one characteristic associated with oral health of a consumer; a memory component that stores a computer application and an at-home oral care treatment regimen customized for the consumer. Embodiments of the computer application cause the system to analyze the input information and assign a gum health indicator for the consumer.

These and other features, aspects and advantages of specific embodiments will become evident to those skilled in the art from a reading of the present disclosure.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, where like structure is indicated with like reference numerals and in which:

FIG. 1 is a flow diagram of the process for providing an at-home oral care treatment regimen to a consumer in accordance with one embodiment;

FIG. 2 is a screen shot which may be used and is an example of block 120 within FIG. 1;

FIG. 3 is a screen shot which may be used and is an example of block 130 within FIG. 1; and

FIG. 4 depicts a system for managing oral health in accordance with one embodiment.

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

As used herein, the term “oral care composition” means a product, which in the ordinary course of usage, is not intentionally swallowed for purposes of systemic administration of particular therapeutic agents, but is rather retained in the oral cavity for a time sufficient to contact substantially all of the dental surfaces and/or oral tissues for purposes of oral activity. The oral care composition may be in various forms including toothpaste, dentifrice, tooth gel, subgingival gel, mouthrinse, mousse, foam, mouthspray, lozenge, chewable tablet, chewing gum or denture product. In one embodiment, the oral care composition is in a form selected from toothpaste, dentifrice, tooth gel, mouth rinse or denture product. The oral care composition may also be incorporated onto strips or films for direct application or attachment to oral surfaces.

The term “dentifrice”, as used herein, includes paste, gel, or liquid formulations unless otherwise specified. The dentifrice can be in a dual phase form, like a striped paste for example, and can also be used as a regimen.

As used herein, “visual indicia” is an identifying marking which may include any illustration, painting, photograph, drawing, picture, logo, hologram or graphic that visually communicates or signals characteristics of an oral care product.

As used herein, “narrative indicia” is an identifying marking which may include letters, numbers or a combination thereof that communicates or signals characteristics of an oral care product.

According to the present disclosure, methods are described for improving the oral health of a consumer and methods for providing an at-home oral care treatment regimen for a consumer. The determination of oral health, including gingivitis and mild to severe periodontitis, is used to characterize various physical and cosmetic characteristics of gum tissue. For example, gum tissue with inflammation (i.e. gingivitis) is unhealthy and may exhibit changes in color, form, position, surface appearance and presence of bleeding and/or exudate. If left untreated, gingivitis may progress to periodontitis, which can be a major cause of tooth loss in adults. Gum health is also connected to overall health. In other words, your mouth is a window to your body's health. Recent studies suggest gum disease may contribute to or be warning signs of potentially life threatening conditions such as heart disease and stroke, diabetes, kidney disease, preterm birth and osteoporosis. Thus, improvement in gum health results in not only better oral health, but better overall health.

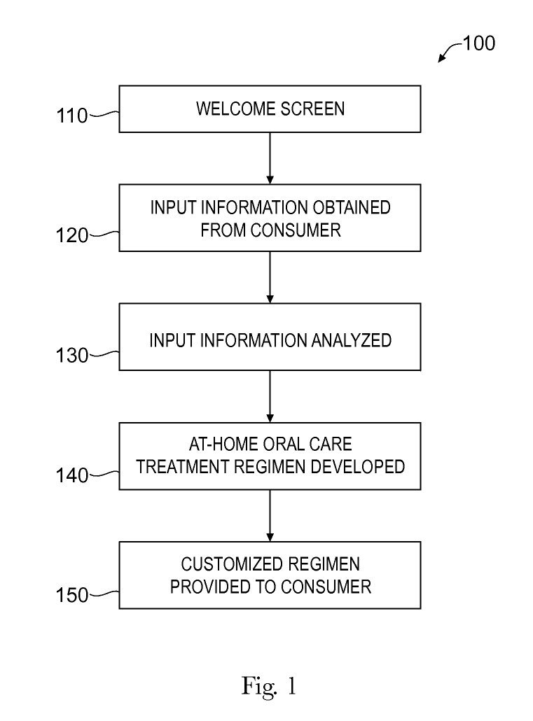

Referring now to FIG. 1, method 100 for improving oral health of a consumer includes the steps of: step 110, welcoming screen; step 120, collecting input information from consumer regarding at least one characteristic associated with oral health; step 130, analyzing the input information; step 140, developing a customized at-home oral care treatment regimen, including identifying at least one oral care product that will be effective in improving the oral health of the consumer; and step 150, providing at-home oral care treatment regimen to consumer. Each of steps 110 to 150 may be represented by screen shots, sheets, reports, or any other form of print materials that are intended to give and receive information to a consumer for purposes of executing method 100. According to one embodiment, these materials may be displayed on a smart device for use with a consumer. As used herein, the term “smart device” refers to any portable device capable of running one or more software applications. Smart devices also can be connected to the Internet or one or more computer networks. Smart devices include, but are not limited to, smartphones (for example, iPhone or Blackberry), pda's, netbooks, GPS devices, tablets, e-readers, iPads, mobile game consoles (for example, Nintendo DS, Sony PSP).

In one embodiment, method 100 is carried out in a dental professional's office with the aid of a device or smart device capable of performing automated data analysis for the purpose of analyzing the input information to assess the oral health of the consumer. The term dental professional includes dentists and dental hygienists. In one example, the automated data analysis may be performed using software. An example of such software is The Oral Health Information Suite (OHIS)™, commercially available from PreViser, Inc. of Mount Vernon, Wash. The system is comprised of a suite of related tools for the major oral health conditions including caries and periodontal disease and is described in more detail in U.S. Pat. No. 6,484,144. Additional examples of such software, include the Florida Probe System and the GoProbe System™, commercially available from Florida Probe Corporation of Gainesville, Fla., and PerioPal®, commercially available from PerioPal LLC of Beaumont, Tex.

In one embodiment, step 110 contains a welcome screen which identifies the system, for example CARE COMPASS, and the associated oral care branded products, for example, Crest® toothpaste and/or Oral B® toothbrush.

Still referring to FIG. 1, step 120 depicts the step of collecting input information from consumer regarding at least one characteristic associated with oral health. In one embodiment, input information is collected from a consumer by a dental professional via a routine periodontal examine in order to determine gum tissue health. This type of examine includes for example, observations of the periodontal tissues including bleeding on probing, plaque, tartar, pockets in gums, and radiographic bone height distance from the cement-enamel junction (CEJ) or gum tissue recession. In one embodiment, if using the OHIS system from PreViser, rather than using the traditional documentation of six pocket depth measurements per tooth, the dental professional will use the greatest measurement or deepest pocket measurement, (for example, <5 mm, 5-7 mm and >7 mm) for each sextant (i.e. upper right, upper anterior, upper left, lower right, lower anterior and lower left). The greatest measurement per sextant is then recorded by the dental professional, for example, by inputting into a smart device or computer running the OHIS software (via work station or wireless keypad) or by recording the measurement on a personalized patient report.

The dentist, dental hygienist or other dental professional may also collect information regarding the distance of the bone crest to the CEJ determined from radiographs. Again, the greatest measurement or distance, (for example, <2 mm, 2-4 mm and >4 mm) for each sextant is collected. The greatest measurement per sextant is then recorded by the dental professional, for example, by inputting into a smart device or computer running the OHIS software (via work station or wireless keypad) or by recording the measurement on a personalized patient report.

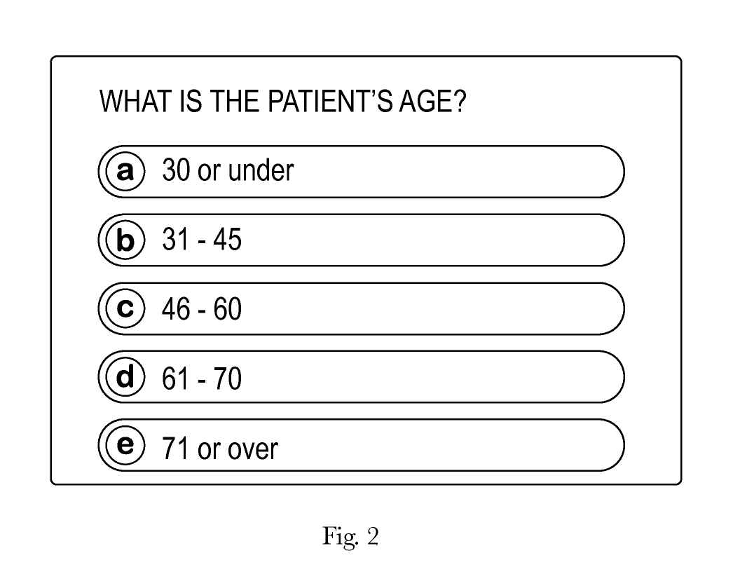

Still referring to FIG. 1, in one embodiment, step 120 also includes collecting information regarding a plurality of risk factors, i.e. the likelihood that a consumer's oral health will get worse without treatment and improved at-home care. These factors include for example, but are not limited to, age, dental care frequency, smoking, diabetes, diet, medication, subgingival calculus, subgingival restorations, furcation involvements, vertical bone lesions, prior perio surgery, missing teeth and overall oral hygiene. This information is then recorded by the dental professional as described above. Referring to FIG. 2, an exemplary screen shot is shown depicting collecting information regarding risk factors, for example, patient's age.

In another embodiment, input information may also be collected from a consumer by a self-assessment, i.e., questioning means, that is, by the consumer's answering questions, which are asked of him or her, either orally or in written form, or electronically, such as via a computer terminal or other imaging device. The questioning means may be an interviewer asking oral questions of the consumer, for example, an interview in a dental professionals' office, a written questionnaire on which the consumer writes answers to the written questions, or an electronic questionnaire viewed by the consumer on a computer screen or other imaging device and for which the consumer submits answers to the questions by typing on a keyboard, touching a responsive screen, speaking an answer, or the like. In another embodiment, the information may be collected from a consumer through the use of an interactive site via the internet. The consumer's response to the questions may then be used to assist in assessing the oral health of the consumer.

With regard to step 120, the precise manner and wording chosen to collect input information from the consumer/patient may vary depending on local custom, the comfort level of consumers in discussing oral care characteristics, and the meaning associated with terms which may be used in different parts of the world to collect information desired. It is to be further understood that the methods of the present disclosure are not to be limited to any one type of question asking methodology or philosophy.

Referring to FIG. 1, step 130, analyzing the input information from step 120, may be performed, at least in part, with the aid of computer hardware and software. For example, the computer may receive input information from step 120 and then perform additional calculations or actions automatically, i.e., without further input from a dental professional. As described above, in one embodiment, a smart device capable of performing automated data analysis for the purpose of analyzing the input information may be used. In one example, step 130 may be performed using commercially available software, for example, the OHIS™ software described above. Step 130 results in a periodontal diagnosis for the consumer that is described using a gum health indicator. In one embodiment, the gum health indicator uses text-linguistic nomenclature. In another embodiment, the gum health indicator uses numeric values. In yet another embodiment, the gum health indicator may use a combination of text-linguistic nomenclature and numeric values.

Traditionally, the stages of periodontal disease are described using text-linguistic nomenclature. For example, the stages of periodontal disease may be described as healthy; gingivitis; mild gum disease; moderate gum disease; and severe gum disease. More specifically, the stages may be described as follows:

TABLE I

| | |
|---|---|
| Healthy | Firm and resilient tissue characterized by |
| | coral pink coloring and minimal sulcus |
| | depth. Variations in gingival color may |
| | occur depending on consumer's |
| | complexion and race. |
| Gingivitis | Inflammation of the gingival characterized |
| | clinically by changes in color, form, |
| | position, surface appearance, and presence |
| | of bleeding and/or exudates. |
| Mild Gum Disease | Progression of the gingival inflammation |
| | into the deeper periodontal structures and |
| | alveolar bone crest, with slight bone loss. |
| | There is usually a slight loss of connective |
| | tissue attachment and alveolar bone. |
| Moderate Gum Disease | A more advanced stage of the previous |
| | condition, with increased destruction of the |
| | periodontal structures and noticeable loss |
| | of bone support, possibly accompanied by |
| | an increase in tooth mobility. There may |
| | be furcation involvement in multi-rooted |
| | teeth. |
| Severe Gum Disease | Further progression of periodontitis with |
| | major loss of alveolar bone support, usually |
| | accompanied by increased tooth mobility. |
| | Furcation involvement in multi-rooted teeth |
| | is likely. |

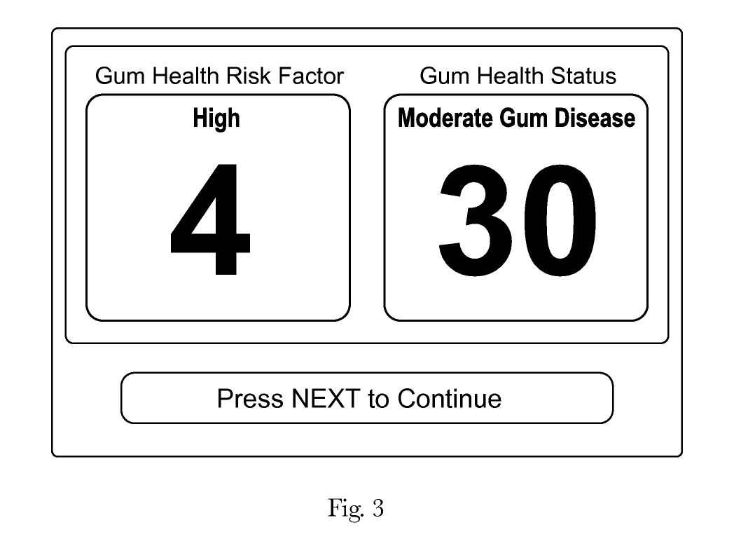

In another embodiment, for example, if step 130 is performed using commercially available software, for example, the OHIS™ software described above, the gum health indicator may use a combination of text-linguistic nomenclature and numeric values. For example, current gum health status may be described as: Healthy (1); Gingivitis (2-3); Mild Gum Disease (4-10); Moderate Gum Disease (11-36); and Severe Gum Disease (37-100). In addition, the gum health indicator may also include a gum health risk factor. For example, the gum health risk factor may be described as: Very Low (1); Low (2); Moderate (3); High (4); and Very High (5), with Very Low being the best and Very High being the worst in terms of risk. Referring to FIG. 3, an exemplary screen shot is shown depicting gum health indicator, which includes the gum health status and gum health risk factor.

After having collected and analyzed the input information from a consumer as described above, step 140 of method 100 calls for developing treatment planning in the form of a customized at-home oral care treatment regimen and then providing the regimen to the consumer in step 150. The goal of steps 140 and 150 is to place the consumer in a position to improve their oral health through the use of an at-home treatment regimen, including, but not limited to, personalized reports, treatment plans, product recommendations, educational tools and motivational tips.

In one embodiment, the general treatment plans are based upon the gum health indicator determined in step 130. Examples of at-home treatment plans according to step 140 are described in Table II below:

TABLE II

| | |
|---|---|
| Healthy | You've been doing all the right things and |
| | taking all the right steps toward getting and |
| | keeping a healthy mouth. Continue |
| | brushing 2 times a day and flossing at least |
| | once a day to keep your oral health as it is. |
| Gingivitis | You are in the early stages of gum disease. |
| | The good news is that it is reversible with |
| | the right at-home oral care. You need to |
| | start brushing 2 times a day, gently floss |
| | every day, and use an antibacterial rinse to |
| | help kill germs and bacteria that can build |
| | up. |
| Mild Gum Disease | You have a mild form of gum disease that |
| | has progressed into the deeper supporting |
| | structures of your teeth and may require |
| | treatment. Proper home care is critically |
| | important. It's important to brush 2 times a |
| | day with an electric toothbrush, gently floss |
| | 2 times a day, and use an antibacterial rinse |
| | 2 times a day to kill germs and bacteria that |
| | are causing your gum disease. |
| Moderate to | Your gum disease involves the loss of |
| Severe Gum Disease | supporting bone structure requiring |
| | treatment by your dental professional. |
| | Treatment and improvements in at-home |
| | care can help prevent future tooth loss. It's |
| | important to brush 3 times a day with an |
| | electric toothbrush, gently floss 2 times a |
| | day, and use an antibacterial rinse each |
| | time you brush. |

In one embodiment, at-home treatment regimens also include customizing the plan to the particular customer, for example, by recommending at least one oral care product, based on the individual needs and oral health of the consumer. In one example, the product recommendation will include a specific product recommendation for improving the gum health indicator of the consumer. Step 140 may further comprise recommending more than one oral care product to a consumer. Exemplary oral care products may include, electric toothbrushes, manual toothbrushes, interdental brushes, gum massagers, floss, and oral care compositions, such as, toothpaste and rinse.

More specifically, in one embodiment, where a consumer received a gum health indicator of “healthy,” the consumer may receive a recommendation for a manual toothbrush, for example, Oral B® Advantage® Complete Whole Mouth Clean toothbrush; a fluoride toothpaste, for example, Crest® Cavity Protection toothpaste, 0.243% sodium fluoride; and dental floss, for example, Crest® Glide Original floss. In another embodiment, where a consumer received a gum health indicator of “gingivitis,” the consumer may receive a recommendation for a manual toothbrush, for example, Oral B® Pro-Health Cross-Action toothbrush; an antibacterial toothpaste, for example, Crest® Pro-Health toothpaste, 0.454% stannous fluoride; antibacterial rinse, for example, Crest® Pro-Health rinse, 0.07% cetylpyridinium chloride; and dental floss, for example, Crest® Glide original floss. In another embodiment, where a consumer received a gum health indicator of “mild gum disease,” the consumer may receive a recommendation for an electric toothbrush, for example, Oral B® Professional Care SmartSeries 5000 with SmartGuide with a Precision Clean replaceable brush head; an antibacterial toothpaste, for example, Crest® Pro-Health Clinical Gum Protection toothpaste, 0.454% stannous fluoride; antibacterial rinse, for example, Crest® Pro-Health rinse, 0.07% cetylpyridinium chloride; and dental floss, for example, Crest® Glide Deep Clean floss. In yet another embodiment, where a consumer received a gum health indicator of “moderate to severe gum disease,” the consumer may receive a recommendation for an electric toothbrush, for example, Oral B® Professional Care SmartSeries 5000 with SmartGuide with a FlossAction replaceable brush head and a PowerTip replaceable brush head; an interdental brush, for example, Oral B® interdental brush; an antibacterial toothpaste, for example, Crest® Pro-Health Clinical Gum Protection toothpaste, 0.454% stannous fluoride; antibacterial rinse, for example, Crest® Pro-Health rinse, 0.07% cetylpyridinium chloride; and dental floss, for example, Oral B® Super floss). The above product recommendations are only examples. The recommendations are customized to the specific needs of the consumer and therefore include a large number of possible combinations of oral care products.

Referring to FIG. 1, the at-home oral care treatment regimen is then provided in step 150 to the consumer by dental professional. In one embodiment, the at-home regimen may be provided to the consumer in the form of, for example, a written report, print-out, or graphical interface outputted to an imaging device. In another example, the at-home oral care treatment regimen may be provided to the consumer through a counseling session with the dental professional. In one embodiment, the at-home treatment regimen may also include visual indicia, for example, pictures of the recommended oral care products to assist the consumer in purchasing the correct products at a retail location. In another embodiment, the at-home treatment regimen may also include brochures or other educational information, including techniques on how to brush, floss and/or rinse in order to improve the oral health of the consumer.

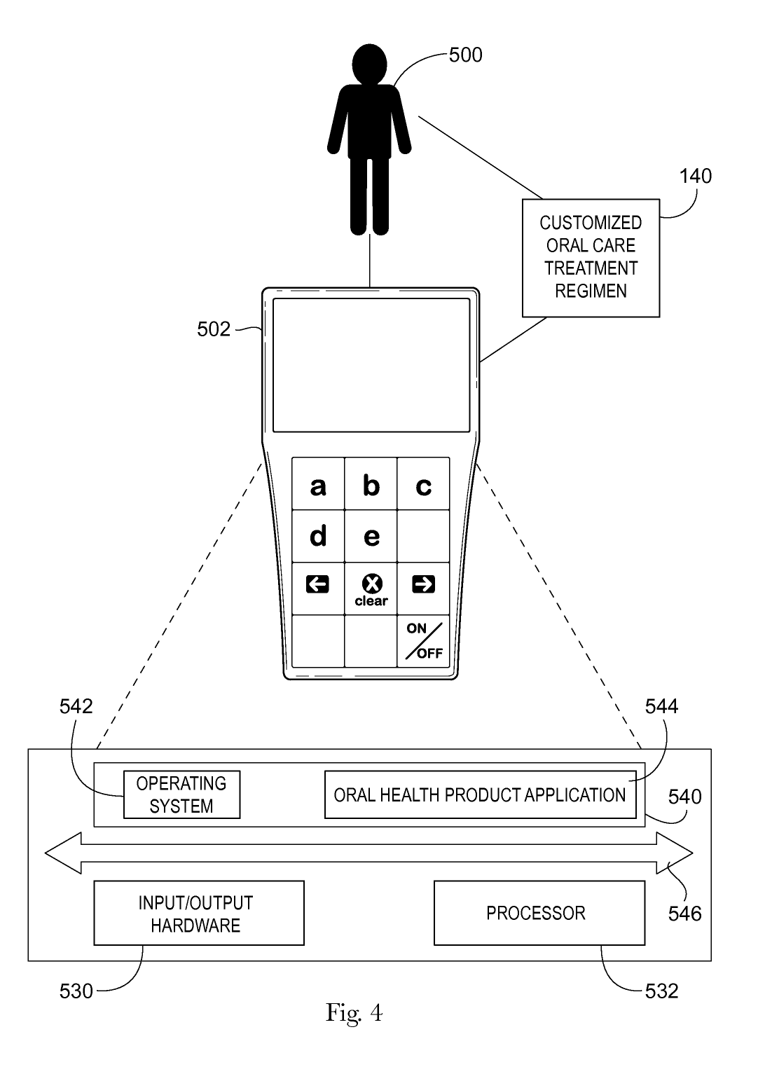

Referring to FIG. 4, a system for managing oral health includes a disease assessment and risk calculator device (DARC) 502. In one embodiment, DARC does not communicate with a computer device and, in some examples, is configured for use independent of a computing device. In another embodiment, DARC 502 is capable of communicating with a computing device via any wired connection, such as through use of a USB connection, serial port or S cable connection, etc., or via any wireless connection, such as a wireless RF connection, infra-red connection, wireless fidelity (Wi-Fi) card, etc.

In one embodiment, the DARC 502 may be configured as a computing device, mobile telephone, personal digital assistant, laptop computer, tablet, kiosk, smart device and/or other device. Additionally, the DARC 502 may include a display for providing a graphical user interface. In another embodiment, the DARC may also include an image capture device configured to capture real-time video images, still images, 3-dimensional images, and/or other images. In another embodiment, the DARC may also include an audio device configured as a speaker and/or microphone for receiving and/or providing audio data to the user.

In the illustrated embodiment, the DARC 502 includes input/output hardware 530, a processor 532 and a memory component 540. The input/output hardware 530 may include and/or be configured to interface with a monitor, keyboard, touch pad, mouse, printer, image capture device, microphone, speaker and/or other device for receiving, sending, and/or presenting data. The processor 532 may include any processing component operable to receive and execute instructions, such as from the memory component. The memory component 540 may be configured as volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the DARC and/or external to the DARC 502.

Additionally, the memory component may be configured to store operating logic 542 and an oral health product application 544. The operating logic 542 may include an operating system and/or other software for managing components of the DARC 502. The oral health product application 544 may include a plurality of different pieces of logic for use in performing automated data analysis of the input information of the consumer, each of which may be embodied as a computer program, firmware, and/or hardware. Alocal interface 546 is also included and may be implemented as a bus or other interface to facilitate communication among the components of the DARC 502.

Referring to FIG. 4, DARC 502 includes a body 504, a key pad 506, and a display screen 508. Body 504 can be shaped and sized to fit comfortably within a user's hand. Display 508, for example an LED display, is viewable by the user and is used to display, for example, the gum health indicators obtained by the DARC 502. Other information may also be displayed by the display. Key pad 506 is used to for entering the input information obtained from the consumer. In one embodiment, key pad 506 may include flat or raised buttons or keys for entering the input information. In another embodiment, key pad 506 may be configured as a touch screen, where the user may simply touch that portion of the screen. Power to the DARC 502 can be manually turned off using interface component 510 here, shown as an ON/OFF button. In some implementations, other component types may be used such as a sliding switch or toggle switch.

In one embodiment, the system for managing oral health also includes a dental professional 500 who uses DARC 502 in order to customize an at-home oral care treatment regimen 140 for the consumer. As discussed above, the goal is to place the consumer in a position to improve their oral health through the use of an at-home treatment regimen, including, but not limited to, personalized reports, treatment plans, product recommendations, educational tools and motivational tips.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for improving oral health of a consumer comprising the steps of:
(a) collecting input information from the consumer regarding at least one characteristic associated with oral health of the consumer;
(b) analyzing the input information;
(c) using the analysis from step (b) to develop a customized at-home oral care treatment regimen, wherein the regimen includes identifying at least one oral care product that will be effective in improving oral health of the consumer; and
(d) providing the at-home oral care treatment regimen to the consumer.

2. The method according to claim 1, wherein the input information is obtained from the consumer via a periodontal exam.

3. The method according to claim 1, wherein the input information is obtained from the consumer by questioning means.

4. The method according to claim 1, wherein the step of analyzing the input information includes an automated data analysis.

5. The method according to claim 4, wherein the automated data analysis is performed using software.

6. The method according to claim 1, wherein the step of analyzing the input information results in a gum health indicator for the consumer.

7. The method according to claim 1, wherein the at least one oral care product is selected from the group consisting of electric toothbrushes, manual toothbrushes, interdental brushes, gum massagers, floss, and oral care compositions.

8. The method according to claim 1, wherein the at-home oral care treatment regimen is provided to the consumer through a written report.

9. The method according to claim 1, wherein information regarding the at least one oral care product is provided to the consumer my means of visual and/or narrative indicia.

10. The method according to claim 1, wherein the steps are performed in a dental office.

11. A method for providing a customized at-home oral care treatment regimen to a consumer comprising the steps of:
(a) assessing the oral health of the consumer;
(b) assigning a gum health indicator, the indicator corresponding to the oral health assessment;
(c) using the gum health indicator to develop the at-home oral care treatment regimen for the consumer; and
(d) providing the at-home oral care treatment regimen to the consumer thereby allowing the consumer to use the at-home oral care treatment regimen in a manner to improve oral health.

12. The method according to claim 11, wherein the oral health of the consumer is assessed via a periodontal exam.

13. The method according to claim 11, wherein the gum health indicator includes a gum health status indicator and a gum health risk factor.

14. The method according to claim 13, wherein the gum health status is selected from the group consisting of healthy, gingivitis, mild gum disease, moderate gum disease and severe gum disease.

15. The method according to claim 13, wherein the gum health risk factor is selected from the group consisting of very low, low, moderate, high, and very high.

16. A system for managing oral health of a consumer, comprising:
a device for inputting and displaying information regarding at least one characteristic associated with oral health of a consumer;
a memory component that stores a computer application, the computer application causing the system to analyze the input information and assign a gum health indicator for the consumer; and
an at-home oral care treatment regimen customized for the consumer.

17. The system according to claim 16, wherein the at-home oral care treatment regimen includes identifying at least one oral care product that will be effective in improving oral health of the consumer.

18. The system according to claim 16, wherein the gum health indicator includes a gum health status indicator and a gum health risk factor.

19. The system according to claim 16, wherein the at-home oral care treatment regimen is provided to the consumer through a written report.
